(19) United States
(12) Patent Application Publication
(10) Pub. No.: US 2021/0019690 A1
(43) Pub. Date: Jan. 21, 2021

(54) TECHNICIAN DISPATCHING METHOD AND SYSTEM

(71) Applicant: ServiceTitan, Inc., Glendale, CA (US)

(72) Inventors: Miles Gordenker, Glendale, CA (US); Boris Parfenenkov, Sverdlovsk Region (RU); Navarathnasothie Selvakkumaran, Glendale, CA (US)

(73) Assignee: Service Titan, Inc., Glendale, CA (US)

(21) Appl. No.: 16/930,236

(22) Filed: Jul. 15, 2020

Related U.S. Application Data
(60) Provisional application No. 62/874,047, filed on Jul. 15, 2019.

(51) Int. Cl. G06Q 10/06; G06Q 10/00

(52) U.S. Cl. CPC G06Q 10/063118; G06Q 10/20

(57) ABSTRACT

Aspects of the present disclosure involve systems, methods, computer program products, and the like, for generating technician dispatching schedules. The dispatching schedule can be generated on demand or on-the-fly based on a plurality of complex factors such as job requirements, technician skill, technician location, job value, technician sales ability, technician location, future job locations, overall availability of other technicians, or other factors. A graph may be used to generate job assignments for the dispatching schedule. Nodes of the graph may respectively represent timeslots and jobs to specific technicians. Methods and apparatus consistent with the present disclosure may be used to assign specific jobs to specific technicians and to specific timeslots, thereby, increasing efficiency and profits of a service company.

### CROSS-REFERENCE TO RELATED APPLICATIONS

The present application claims the priority benefit of provisional U.S. patent application 62/874,047, filed Jul. 15, 2019, the disclosure of which is incorporated by reference herein.

### BACKGROUND OF THE INVENTION

### Field of the Invention

The present invention generally relates to generating a dispatching schedule for technicians to requested service sites. More specifically, the present invention is directed to generating work schedules based on a skillset and an availability of particular technicians.

### Description of the Related Art

Technicians deployed to service request sites, may generate different amounts of revenue based on a plurality of factors and, as a result, it is often preferable to dispatch technicians according to a schedule that considers all of the factors that are necessary for a technician to complete an assignment. Typically, a simple model and/or manual assignment is used to generate a dispatching schedule. However, such typical methodologies are often slow, inflexible, and/or non-optimal (e.g., there are scheduling solutions for the technicians that generate higher net revenue from all performed jobs, etc.).

What are needed are new methods and apparatus that more efficiently schedule and dispatch service technicians to provide services for customers. It is with these observations in mind, among others, that aspects of the present disclosure were concerned and developed.

### SUMMARY

Embodiments of the present invention generally relate to systems and methods for dispatching technicians to service locations.

In one embodiment, a computer-implemented method for dispatching technicians includes receiving a job request including job location information, accessing a list of service technicians and associated availability for each listed service technician, the list of service technicians including service technicians respectively associated with a skill set corresponding to the request, generating a list of time windows to which the received job request may be assigned, each time window associated with a respective service technician from the list of service technicians and associated with a prediction of generated revenue from the job, the prediction based on the time window, the respective technician, and the job, and scheduling a selected service technician of the list of service technicians to undertake the job by associating the selected service technician with the time window and a type of service associated with the job.

In one embodiment, the computer-implemented method is a performed as a non-transitory computer-readable storage medium, where a processor executes instructions out of a memory to receive a job request including job location information and access a list of service technicians and associated availability for each listed service technician, the list of service technicians including service technicians respectively associated with a skill set corresponding to the request. Here again the method may include generating a list of time windows to which the received job request may be assigned, each time window associated with a respective service technician from the list of service technicians and associated with a prediction of generated revenue from the job, the prediction based on the time window, the respective technician, and the job. Next, a selected service technician of the list of service technicians may be scheduled to undertake the job by associating the selected service technician with the time window and a type of service associated with the job.

### BRIEF DESCRIPTION OF THE DRAWINGS

The description will be more fully understood with reference to the following figures, which are presented as various embodiments of the disclosure and should not be construed as a complete recitation of the scope of the disclosure, wherein:

FIG. 1 is a block diagram of an example dispatching system, in accordance with various embodiments of the subject technology;

FIG. 2 is a flowchart depicting an example method for generating a dispatching schedule, in accordance with various embodiments of the subject technology;

FIG. 3 is a flowchart depicting an example method for generating a dispatching schedule, in accordance with various embodiments of the subject technology; and

FIG. 4 is a flowchart depicting an example method for assigning a technician to a job, in accordance with various embodiments of the subject technology;

FIG. 5 is an illustration of an example interface for assigning a job to a timeslot, in accordance with various embodiments of the subject technology;

FIG. 6 is a diagram illustrating an example of a computing system which may be used in implementing various embodiments of the present disclosure.

### DETAILED DESCRIPTION

Aspects of the present disclosure involve systems, methods, computer program products, and the like, for dispatching schedule of technicians to requested sites (e.g., jobs). In particular, the dispatching schedule can be generated on demand or on-the-fly and is based on a plurality of complex factors such as technician skill, technician location, job value, technician sales ability, technician location, future job locations, overall availability of other technicians, etc. As a result, a dispatching schedule can be generated that may realize an otherwise increased revenue across all jobs than typical dispatching schedules generated through other methodologies. Methods consistent with the present disclosure may be implemented by computing devices that receive requests for jobs to be performed at specific location that may be referred to as “job sites.”

In one example, a dispatching computer system may be configured to run a scheduling program on a regular basis (e.g., every five minutes, 10 minutes, hourly, daily, etc.) to update dispatching schedules for changes in technician availability (e.g., technicians newly labeled as available at various time intervals or calling in sick, etc.), job requests (e.g., receipt of urgent job requests, etc.), local conditions (e.g., weather, traffic, etc.), and/or various other factors. Upon running, the dispatching system may retrieve an appropriate model for a respectively scheduled tenant (e.g., company customer, etc.) to generate a dispatching schedule based on particularities specific to the respective tenant (e.g., technician rate information, business unit information, service locations, etc.).

The dispatching computer system may then generate a dispatching schedule using job value prediction information partially based on the retrieved model. In some examples, the model may be retrieved from a relational database or the like using, for example and without imputing limitation, structured query language (SQL), etc. The dispatching schedule may be stored for later retrieval and/or distributed to technicians in the field. In one embodiment of the method, the method is performed on a scheduled basis at regular intervals.

In one example, generating a dispatching schedule includes defining an interval of time over which to generate the dispatching schedule, retrieving information on available time for technicians associated with the respective tenant, retrieving information for jobs to be assigned to technicians and for jobs which have been manually assigned to technicians, and retrieving non-job event (e.g., time off, medical leave, parental leave, etc.) information regarding the technicians. Job information may include, for example and without imputing limitation, job status (e.g., scheduled, dispatched, or working), estimated cost, timing information (e.g., estimated start and/or end time, etc.), location information, and/or assignment information pairing a technician to the respective job. In some examples, non-job events may be represented as manually assigned jobs and thus similarly be locked to a scheduling window for the respective technician (e.g., the dispatching system may refrain from rescheduling the event, etc.).

Once the dispatching system generates a dispatching schedule, some jobs may be unassigned and so can be flagged as such. For example, jobs which do not include location (e.g., address), cost, etc. information may be flagged as awaiting assignment until the missing information is provided. Likewise, jobs may be unable to be assigned due to technician unavailability due to a lack of technicians having availability and a required skill set. In some examples, unassigned jobs can be flagged as awaiting manual correction instead of, or in addition to, awaiting assignment. In some examples, an appropriate user can be alerted to provide manual correction, etc.

The dispatching schedule may be provided to respective technicians as an update or an alert. In some examples, technicians may retrieve the dispatching schedule manually, for example and without imputing limitation, via a web application or the like, which may maintain the most recently generated dispatching schedule. Additionally, technician performance and/or predicted performance information may be updated (e.g., projected revenues, etc.) as a result of the dispatching schedule.

In some examples, a bipartite graph is used to generate job assignments for the dispatching schedule. Nodes of the bipartite graph may respectively represent timeslots (e.g., for assigning a technician to a job) and jobs. Each timeslot may be associated with a particular technician so, for example, one set of timeslots, and thus nodes, may be associated with a first technician whereas another set of timeslots, and thus another set of nodes, may be associated with a second technician. Edges of the bipartite graph may interconnect job nodes to timeslot nodes and each associated with a cost based on a calculated value of the job. In some examples, the edge costs may additionally be modified by a multiplier associated with the particular technician (associated with the particular timeslot).

In one embodiment of the method, generating the list of time windows includes generating a bipartite graph including a first set of nodes associated with time windows associated with a particular technician of the list of service technicians, a second set of nodes associated unassigned jobs, and edges interlinking nodes of the first set of nodes and nodes of the second set of nodes, each edge associated with a cost value, and solving the bipartite graph by iteratively removing edges until no two nodes are linked by more than one edge.

In particular, where the edge costs are the negative value of respective job node values multiplied by respective technician multipliers, the bipartite graph can be solved to minimize the cost of the edges surviving the solution. The bipartite graph can be considered solved when each timeslot is associated with one or fewer edges to job nodes. In effect, the solved bipartite graph provides a technician dispatching schedule, in the form of technician timeslots connected to jobs by edges, optimized for increased revenue realization because the lowest cost edges correlate to the highest value job assignments (e.g., job value multiplied by a technician multiplier). As a result, the solved bipartite graph may provide an optimal dispatching schedule, for example and without imputing limitations, in the form of recommended assignments. In one embodiment of the method, iteratively removing edges from the bipartite graph includes performing simulated annealing over the bipartite graph.

In one embodiment of the method, the cost is a negative value based on a predicted value of a job associated with a first respective node of the second set of nodes and a technician multiplier associated with a second respective node of the first set of nodes.

Assignments may be represented as a tuple of a technician identifier, a job identifier, and a timeslot associated with the technician. Each job may only be assigned once in the solved bipartite graph. Likewise, each timeslot (per technician) may only be assigned once in the solved bipartite graph. Solving the bipartite graph may be performed by, for example and without imputing limitation, annealing methods, machine learning methods (e.g., deep learning, etc.), and various other methods. An annealing process may include receiving a set of requirements or parameters associated with a particular job. Such requirements or parameters may include information that identifies specific technicians, skill levels of those technicians, a reason for dispatching the technician (e.g. a customer reported issue), a location where a selected technician should be dispatched (i.e. a job location), and a time frame that the selected technician should arrive at the location to perform the service. From these initial parameters, one or more scheduling solutions may be calculated and first minimum time for resolving the reason for resolving the customer reported issue may be identified. For example, a technician skill rating or other rating factor may be used to assign certain types of jobs to a certain technician when a schedule is generated. In another iteration that skill rating may be ignored when another schedule is generated. Next, the first minimum time can be identified, for example, by comparing cost factors associated with each schedule. These initial solutions may then be performed again after changing another requirement associated with a plurality of technicians performing a plurality of tasks in a given time frame. For example, a requirement that technician A perform service for customer ABC may be changed to indicate that technician B may alternatively perform that service for customer ABC when a schedule that includes many services that must be performed in a day by both technician A and technician B.

This annealing process may include identifying a path that would be traversed by a specific technician (e.g. technician A) when performing a set of services at different job locations. This process may also include adding a new job within that path, and recalculating a new scheduling solution. Alternatively, a job within the original path of technician A may be removed and the new scheduling solution may be calculated. Other examples of such iteratively generated schedules may include moving a job from one technician to another, reordering jobs within a particular technician's path, or swapping two jobs between different technicians. Paths assigned to the technicians may include a set of sub-paths (e.g. a first path through a first neighborhood or geo-zone and a second path through a second neighborhood/geo-zone) and those sub-paths may be swapped between technicians when other new scheduling solutions are generated. These neighborhoods or geo-zones may be locations identified on a map or locations that are within a specified distance or traveling time of each other. In certain instances routes may be re-assigned to reverse direction.

Each of the different scheduling solutions may include steps that identify driving times from one location to another, traffic patterns, estimated traffic data, traffic data collected in real-time (e.g. current accidents or current average vehicle speed), estimated time a particular technician could likely perform a service, or other factors. Scheduling solutions may be associated with heuristics that may be associated with ranked alternatives, for example, a heuristic may result in scheduling solutions being generated only for a set of job locations that are closest to a specific technician. Other sets of schedules may be generated by removing or adding a job randomly from a technician's schedule or swapping jobs randomly between technicians.

Each of the requirements, parameters, or factors used to generate schedules may be assigned with a probability. For example, technician A may have a greater probability of performing service of installing a new 208 volt three-phase electric service drop at a customer location faster than technician B. This greater probability may increase the likelihood that technician A will be assigned with installing the new 208 volt electrical service drop. Such processes allow for technician schedules and routes to be dynamically updated based on real-time conditions.

In one example, a maximum-flow-minimum-cost process may be used to solve the bipartite graph. In particular, the maximum-flow-minimum-cost solved first maximizes the number of jobs assigned and then minimizes the cost of the assigned jobs (e.g., maximizing value of respective jobs).

In some examples, the above approach may be used to identify and label available timeslots for a job for manual assignment to a technician. For example, a customer service representative (CSR) may receive a job request from a customer and select from a plurality of per-technician timeslots in order to maximize potential revenue from the job. Table 1 below shows an example of pseudo-code using a maximum-flow-minimum-cost solution to a bipartite graph to generate labeled timeslots and/or identify an optimal timeslot for a job.

TABLE 1

```
for k in 1 ... S:
  jsCopy = copy(js)
  jsCopy[1] = k
  graph = buildGraph(t, s, j, ts, tj, jsCopy)
  solution = maxFlowMinCost(graph)
  timeslotValue[k] = -solution.cost
```

In Table 1 above, s represents a set of timeslots with S being the last timeslot in s, t represents a set of technicians, and j represents a set of jobs. Furthermore, ts is an adjacency matrix of sets t and s, tj is an adjacency matrix of sets t and j, and js is an adjacency matrix of sets j and s. Cells in adjacency matrix ts may contain a 1 (e.g., a Boolean True value, etc.) if the respective technician (member of set t) is available at the respective timeslot (member of set s). Accordingly, cells in adjacency matrix ts may otherwise contain a 0 (e.g., a Boolean False value, etc.). Technicians are available at a timeslot unless they are already assigned to another job (e.g., via manual assignment, etc.) or have an overlapping non-job event.

Cells in adjacency matrix tj may contain a 1 if a respective technician can be assigned (e.g., has a matching skill set) to a respective job, and may otherwise contain a 0. For example, a technician specialized as an electrician may not be assigned to a job of an HVAC repair, where an HVAC technician may and accordingly a cell correlating the HVAC technician and the HVAC repair job may contain a 1.

Cells in adjacency matrix js contain an index of a respective timeslot to which a respective job is assigned. Where a job is not assigned to a timeslot, the respective cell contains a 0. The data structure graph is a bipartite graph constructed out of sets t, s, j (e.g., nodes) and adjacency matrices ts, tj, and jsCopy, a copy of js (e.g., edges). A solution may then be found for graph using, for example, maxFlowMinCost, which is a maximum-flow-minimum-cost solver and provides a value for assigning the job (e.g., for which a request is received by a CSR as described above) for each timeslot for respective technicians based on an inversion of the cost. This can be repeated for each technician timeslots to generate a selection of timeslots which can be selected for booking the job and which include revenue predictions of the job in that timeslot. As a result, CSRs can optimally assign technicians to job requests based on predicted revenue and overall efficiency across a plurality of potential technicians. Maximum-flow-minimum-cost solutions may minimize distances that specific technicians drive from one job site/location to another throughout the day. Maximum-flow-minimum-cost solutions may include identifying a time window/frame to assign to for a technician to arrive at a particular job location to perform a particular service. Next, sets of available technicians and available time slots to which those available technicians can be scheduled may be identified. After this, each of the technicians may be assigned particular jobs and time slots to perform those jobs as part of a maximum-flow-minimum-cost scheduling process. The purpose of this maximum-flow-minimum-cost scheduling process is to find a cheapest (lowest cost) way of providing a plurality of services to customers in a timely way. This process may include associating a service with job locations and time slots of a graph that includes many job locations and time slots. Each of these locations may be represented by a node of the graph. Calculations may then be performed to identify a sequence of events that would allow a set of services to be performed at each of these job locations in a manner that matches time slots assigned to each service and a minimum cost. This process may be initiated using a series of initial parameters or selections after which different parameters or sections may be used to generate a new sequence of events and a least cost solution may then be identified and applied to work schedules for each of a set of service technicians.

This process may also include additional calculations that span multiple sets of nodes when identifying a minimal cost for providing a maximum or optimal number of services associated with the multiple sets of nodes. For example, a first set of nodes may be associated with a first set of job locations, time frames, and services that need to be performed in East San Jose, and a second set of nodes may be associated with a second set of time frames, and services that need to be performed in South San Jose. Initially, work schedules for a first set of technicians based in or assigned to East San Jose may be generated and schedules for a second set of technicians based in or assigned to South San Jose may be generated. Next, parameters and requirements associated with each of the two sets of nodes may be used to re-schedule tasks assigned to South San Jose technicians to East San Jose technicians or visa-versa. As such, services required to be performed in both East and in South San Jose may be completed with a minimal cost based on the maximum-flow-minimum-cost scheduling process. This may be true because certain locations in East San Jose are closer to specific locations in South San Jose than other locations in South San Jose: in a circumstance when East San Jose technician is currently closer to a next job location in South San Jose, the next job located in South San Jose may be assigned to the East San Jose technician based in part on a minimal traveling distance cost.

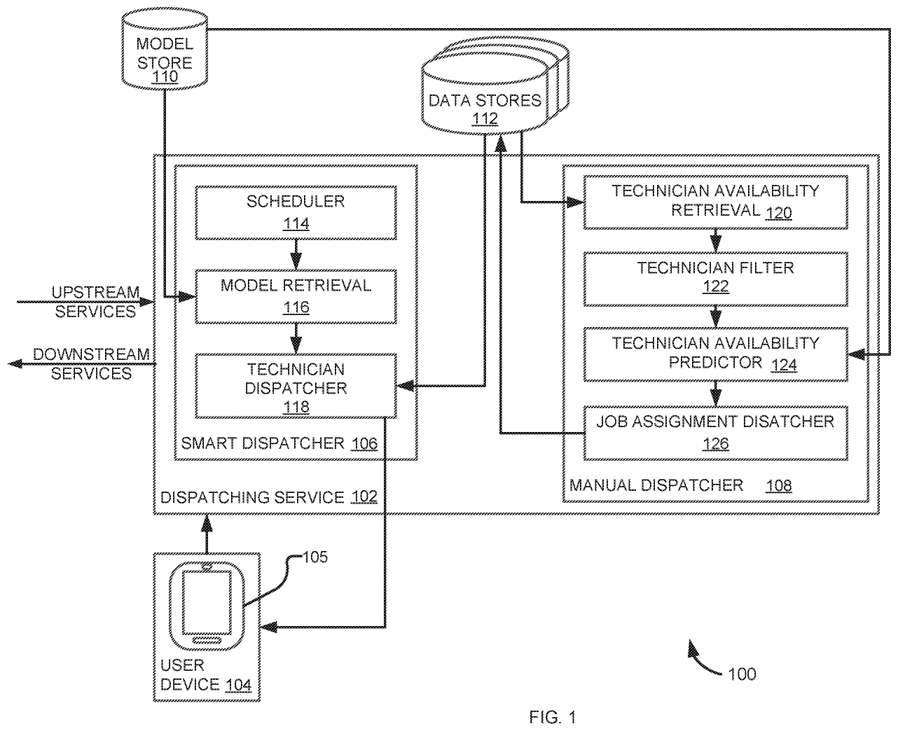

The disclosure now turns to a discussion of FIGS. 1-6 to provide further understanding of the technologies herein disclosed. It is understood that such discussion is for explanatory purposes and is not taken to be limiting. Variations on the systems and methods discussed herein, and in the figures below, may be realized without departing from the spirit and scope of the disclosure.

FIG. 1 is a block diagram illustrating an example dispatching system 100. Dispatching system 100 can perform the systems and methods disclosed above and, in some examples, may be stored, in part, on a remote server or cloud host. For example, dispatching system 100 may include a user device 104, such as a tablet computer 105 or the like, accessing a dispatching service 102 via network connection (e.g., radio Internet, mobile network, WiFi, etc.) and a web portal, such as in the case of a web application.

In particular, dispatching service 102 may receive data from upstream services and provide data to downstream services. Upstream services can include, for example and without imputing limitation, job value prediction systems, manual requests from CSRs, etc., reporting systems, and the like. Downstream services may include, for example and without imputing limitation, cloud storage providers, tenant (e.g., user) data stores, analytics and/or data processing services, and the like.

Dispatching service 102 includes a smart dispatcher 106 and a manual dispatcher 108. Smart dispatcher 106 may automatically generate a dispatching schedule on a predetermined basis and distribute the generated dispatching schedule as an update to technicians. Manual dispatcher 108 may generate a dispatching schedule on request from, for example, a connecting CSR or the like. Additionally, dispatching service 102 is connected to data stores 112 and model store 110. Data stores 112 store various information for generating a dispatching schedule such as, for example and without imputing limitation, job information, technician information, and tenant information. Model store 110 may store models for retrieval by dispatching service 102. Models stored by model store 110 may be associated with particular tenants (e.g., users, companies, etc.) and can be executed to generate a job value prediction based on job information retrieved from data stores 112, etc.

Smart dispatcher 106 includes a scheduler 114, model retrieval 116, and technician dispatcher 118. Scheduler 114 may initiate smart dispatcher 106 on a scheduled basis. In some examples, scheduler 114 can store one or more customized schedules associated with respective tenants. Upon initiation by scheduler 114, model retrieval 116 retrieves an appropriate job value prediction model from model store 110 to generate a dispatching schedule. Model retrieval 116 may provide the retrieved model to technician dispatcher 118, which retrieves information from data stores 112 and executes the retrieved model to generate job value predictions before further generating a dispatching schedule utilizing said job value predictions. The generated dispatching schedule may then be provided directly to user devices 104 or indirectly via alerting system informing users that the generated dispatching schedule is available for retrieval and/or review.

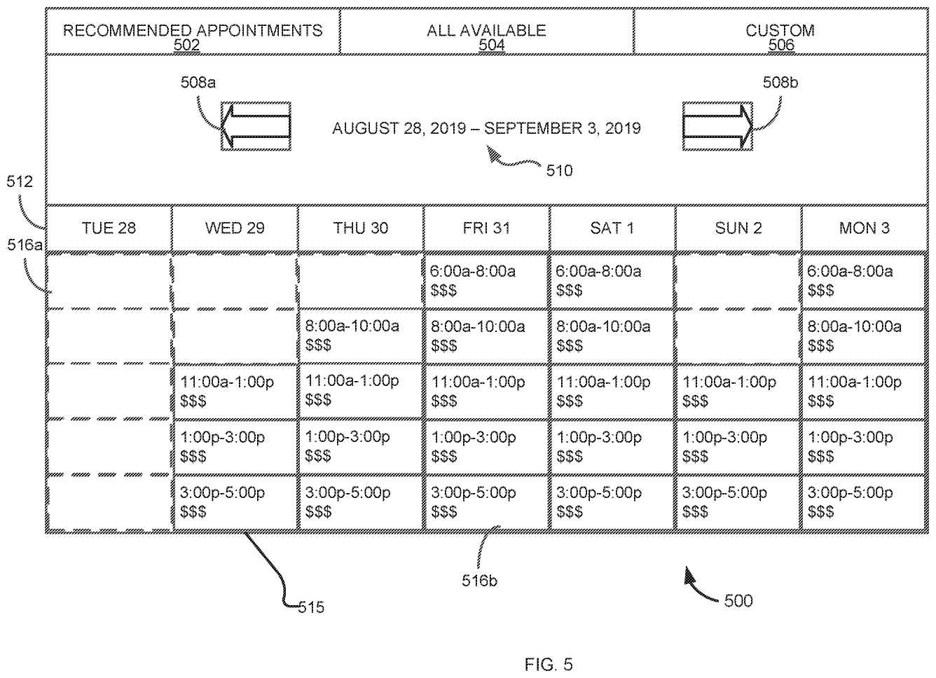

Manual dispatcher 108 includes a technician availability retrieval 120, a technician filter 122, a technician availability predictor 124, and a job assignment dispatcher 126. Manual dispatcher 108 may be accessed by user device 104, such as in the case of a CSR receiving a service request from a customer or the like. In particular, manual dispatcher 108 can generate a calendar view of possible job assignments paired with a revenue prediction reflective of the job being assigned to the particular timeslot (as depicted by FIG. 5 and further discussed below).

Technician availability retrieval 120 retrieves technician information and availability (e.g., current technician schedules, etc.) from data stores 112. Technician filter 122 applies filters to the retrieved technician information based on, for example and without imputing limitation, geographic location, skill set, and the like. In some examples, model store 110 may also store models for predicting technician availability and technician availability predictor 124 may retrieve respective technician availability models from model store 110 to predict whether a technician will remain available for particular timeslots. Based on the filtered and modeled technician availability information and skills, job assignment dispatcher 126 may produce a view of preferred timeslots to which to assign the service request. In some examples, once a timeslot has been chosen, it may be provided to data stores 112 for later retrieval by downstream services, such as a technician calendar or scheduling application or the like.

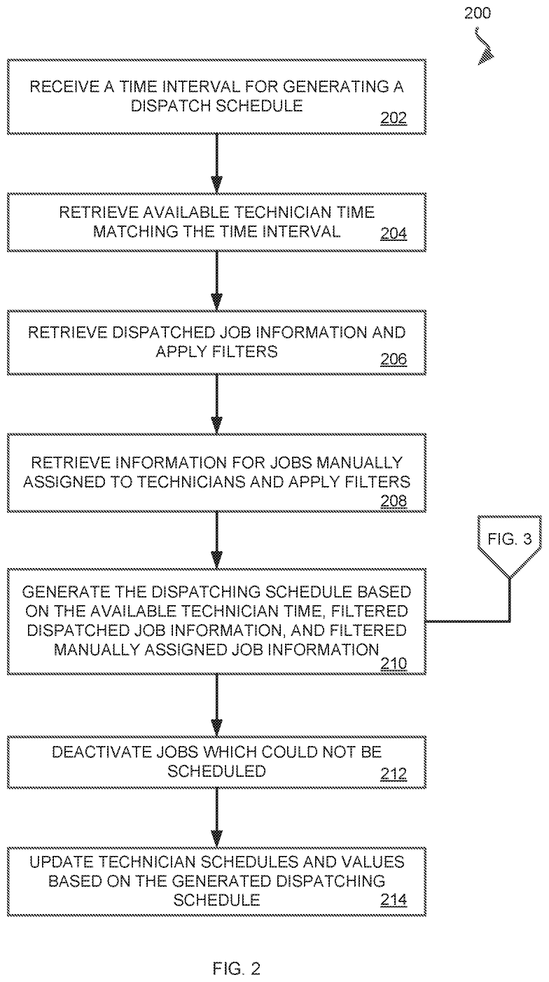

FIG. 2 is flowchart depicting a method 200 for dispatching technicians to service sites. In some examples, method 200 may be performed by manual dispatcher 108 discussed above. Method 200 starts at step 202, where a time interval is received for generating a dispatch schedule.

At step 204, available technician time matching to the time interval is retrieved. The available technician time may be retrieved from a data store, such as data stores 112, storing technician information. At step 206, dispatched job information is retrieved and filters are applied. For example, and without imputing limitation, the retrieved jobs may be filtered by status (e.g., scheduled, dispatched, working, etc.), estimated cost, timing information (e.g., start time, end time, etc.), location information, assignment information, etc.

At step 208, information for manually assigned jobs is retrieved. In some examples, jobs assigned to multiple technicians may be retrieved at this step. Additionally, filters may be applied, such as, for example and without imputing limitation, status, timing information, etc. Further, in some examples, non-job events, such as time off, sick days, etc. may be retrieved with the manually assigned job information.

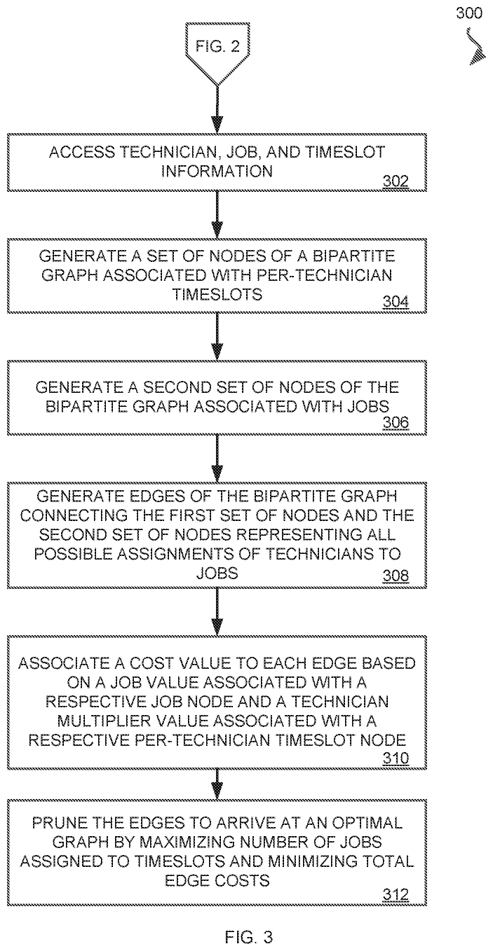

At step 210, the dispatching schedule is generated based on the available technician time, filtered dispatched job information, and filtered manually assigned job information. In some examples, generating the dispatch schedule may be performed using a heuristic solver. In some examples, simulated annealing or other solvers may be used (as discussed in reference to FIG. 3 below).

At step 212, jobs which could not be scheduled are deactivated from further scheduling. For example, jobs lacking information such as location or address details, cost information, etc. may remain unscheduled. As a result, the jobs are deactivated. At step 214, technician schedules are updated and values on the generated dispatching schedule are updated. For example, job alert information, technician current and/or projected values, and the like may be updated based on a most recent dispatching schedule.

FIG. 3 is a method 300 for generating a dispatching schedule. In some examples, method 300 may be performed automatically on a predetermined basis. In some examples, method 300 may be performed on demand (e.g., when a CSR is seeking to assign a technician to a service request). Here, method 300 may be executed as part of, or in addition to, method 200 discussed above in reference to FIG. 2.

At step 302, technician, job, and timeslot information are accessed. In some examples, technician, job, and timeslot information may be provided directly to method 300 as part of an initialization procedure. In other examples, the technician, job, and timeslot information may be retrieved from, or accessed on, a remote server such as a cloud data store or the like. Technician information may include technician identification, specialty, pricing information, revenue generation information, and the like. Job information may include skill requirements, timing information, location information, property and/or customer information, and the like. Timeslot information can include mappings to individual technicians and/or jobs assigned to the respective timeslot.

At step 304, a set of nodes of a bipartite graph are generated that are associated with timeslots assigned to respective technicians. At step 306, a second set of nodes of the bipartite graph are generated and are associated with jobs based on the job information.

At step 308, edges are generated for the bipartite graph and connect the first set of nodes and the second set of nodes. In particular, the edges represent all possible assignments of technicians to jobs. For example, each technician having adequate availability to perform a particular job may be represented as respective edges connecting a node associated with the particular job to timeslot nodes respectively associated with respective technicians.

At step 310, cost values are assigned to each edge based on respective job values and a multiplier associated with respective technicians. Further, in some examples, the cost value is the negative value of the job value and multiplier. For example, a job node may be associated with a predicted value of $100 and the respective technician may be associated with a multiplier of 1.5. As a result, the edge is assigned a cost value of −150. In some examples, the job value is generated by an upstream service such as the job value prediction system described in <TODO: insert application number for converted provisional for JVP system>, herein incorporated by reference in its entirety. As a result, a naïve bipartite graph is constructed which may be processed to generate an optimal dispatching schedule.

At step 312, the edges are pruned in order to arrive at an optimal graph by maximizing the number of jobs assigned to timeslots and minimizing the total cost of the edges. In particular, where edges costs are assigned to a negative, the resultant solution will describe the maximally valued edges and, accordingly, job and technician combinations. In some examples, a maximum-flow-minimum-cost process can be used to prune the edges. In some examples, simulated annealing may be used to prune the edges.

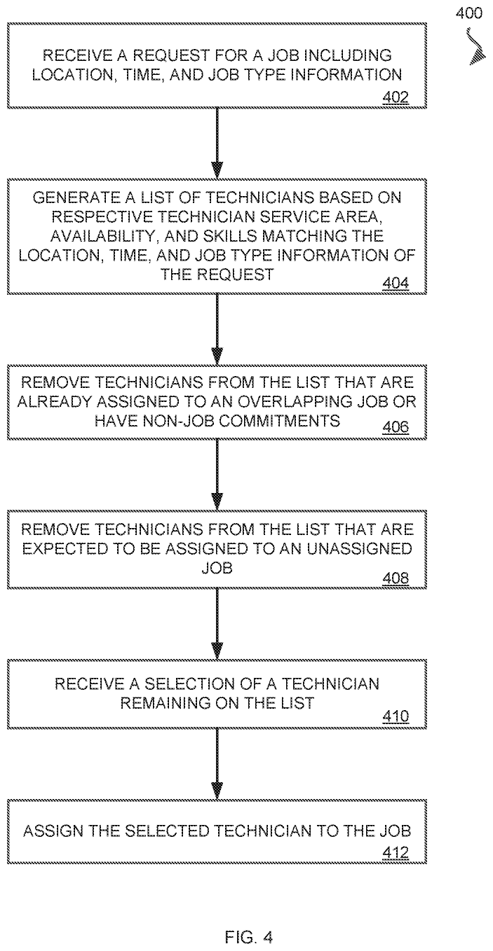

FIG. 4 is a method 400 for manually assigning a technician to a job (e.g., updating or generating a dispatching schedule). For example, a CSR may receive a customer call requesting a job to be performed and method 400 may be used to assign a preferred technician to the job.

At step 402, a request is received for a job including location, time, and job type information. In some examples, the CSR may manually enter the location, time, and job type information based on answers from a calling customer. At step 404, a list of technicians is generated based on respective technician service area, availability, and skills matching the location, time, and job type information of the request. Technician service area, availability, and skills information can be retrieved automatically from, for example, data stores 112 discussed above in reference to FIG. 1. Types of jobs could by classified into categories and sub-categories. For example, a job type could be related to categories of plumbing, electrical, computer network services. Furthermore, specific job types may be identified as a category of plumbing and sub-categories of drain clearing, pipe laying, pipe repair, sewage smell abatement, septic tank repair.

At step 406, technicians are removed from the list that are already assigned to an overlapping job or have non-job commitments. In some examples, an existing dispatching schedule may be checked to identify already existing assignments and/or non-job commitments. In some examples, existing assignments and non-job commitments may be included in technician information objects as, for example and without imputing limitation, a schedule or calendar field, or the like.

At step 408, technicians that are expected to be assigned to unassigned jobs are removed from the list. For example, a predictive model for the technician may predict that the technician is likely to be assigned to a superior (e.g., higher value, etc.) job assignment. In some examples, technicians may have pending job assignments yet to be finalized and the pending job assignments (e.g., unassigned jobs) may take priority over the requested job.

At step 410, a selection of a technician remaining on the list is received. For example, a graphical user interface (GUI) may provide an interactive listing of technicians that may be assigned to the job to the CSR. As a result, the CSR may select one of the displayed technicians. At step 412, the selected technician is assigned to the job. In some examples, the assignment causes an alert to be provided to the technician informing them of the new assignment. The assignment may be sent as an electronic message to a computing device of the selected technician.

Computing devices of a technician may include a processor that executes instructions that may be part of an application program installed on or residing at each respective technician user computing device. The application program at these user devices may invoke audio or video messages that inform a technician of an upcoming or a next appointment. Such program applications may allow a technician to call a customer before the technician arrives at a customer location. The technician could initiate such a call by making a selection in a user interface (such as a graphical user interface) or could initiate a call to the customer using a voice command. While scheduling information may be stored at computing devices of technicians, such scheduling information may be stored at a centralized scheduling or dispatch computer that may be accessed by the technician computing devices. As such, technicians may access scheduling information by using an application program or by accessing the centralized computer, for example, via a web browser.

FIG. 5 is an illustration of a graphical user interface (GUI) 500 which a CSR may use to assign a technician to a job request. In some examples, the CSR may perform method 400 discussed above in reference to FIG. 4, in part or in whole via GUI 500.

GUI 500 includes header tabs 502-506, via which a user (e.g., the CSR, etc.) may change views. In particular header 502 for recommended appoints is depicted in FIG. 5. Nonetheless, header tab 504 may change the view to all available timeslots for booking and header tab 506 may change the view to a customized view.

Calendar section 515 includes a collection of timeslots sequentially organized by day and hour. In particular, calendar section 515 is divided into a week of days demarcated by day columns 512. Here, Tuesday the 28^{th} through Monday the 3^{rd} are depicted. FIG. 5 includes arrows/boxes 508a and 508b that may be used to scroll a calendar from a currently displayed week 510 of Aug. 28, 2019 through Sep. 3, 2019 to either a previous week or a next week. When selection arrow/box 508a is selected, a schedule for a previous week may be displayed in GUI 500 and when selection/arrow box 508b is selected a schedule for a next week may be displayed in GUI 500.

Each respective day is broken into five timeslots correlating to two hour increments beginning at 6:00 am and concluding at 5:00 pm. For example, a first timeslot in a day column 512 correlates to a 6:00 am-8:00 am timeslot. Likewise, a fifth timeslot in a day column 512 correlates to a 3:00 pm-5:00 pm timeslot.

Further, timeslots may be one of two general types. An unassignable timeslot 516a displays a blank timeslot space to indicate that no technician is available for assignment. In comparison, timeslots 516b include a time window indicator (e.g., 3:00p-5:00p, etc.) and a value indicator in the form of sequential “$” symbols. The value indicator provides a clear indicator of a preference level for assigning a technician to the respective timeslot based on the predicted revenue from the assignment. For example, a timeslot with a “$$” value indicator (not depicted) is predicted to generate less revenue than a timeslot with a “$$$” value indicator. In some examples, a user may interact with timeslots 516b to bring up a list of technicians that may be assigned to the timeslot. The list may be generated according to the systems and methods discussed above.

Once a technician completes a job, scheduling information may be updated automatically. For example, if a technician completes a job before the end of a two hour period or after the end of a two hour period, information in the GUI 500 could be updated to identify an actual amount of time that the technician spent performing the job. GUI 500 may also be updated to reflect changes in values, this may occur when a technician identifies and performs additional work for a particular customer. As such, methods consistent with the present disclosure may schedule future events and also track and update work related details as that work is performed. Furthermore, schedules could be re-generated each time a technician provides information to a scheduling computer. For example, when a first technician is expectantly delayed, a second technician may be assigned and dispatched to a job location dynamically on-the-fly.

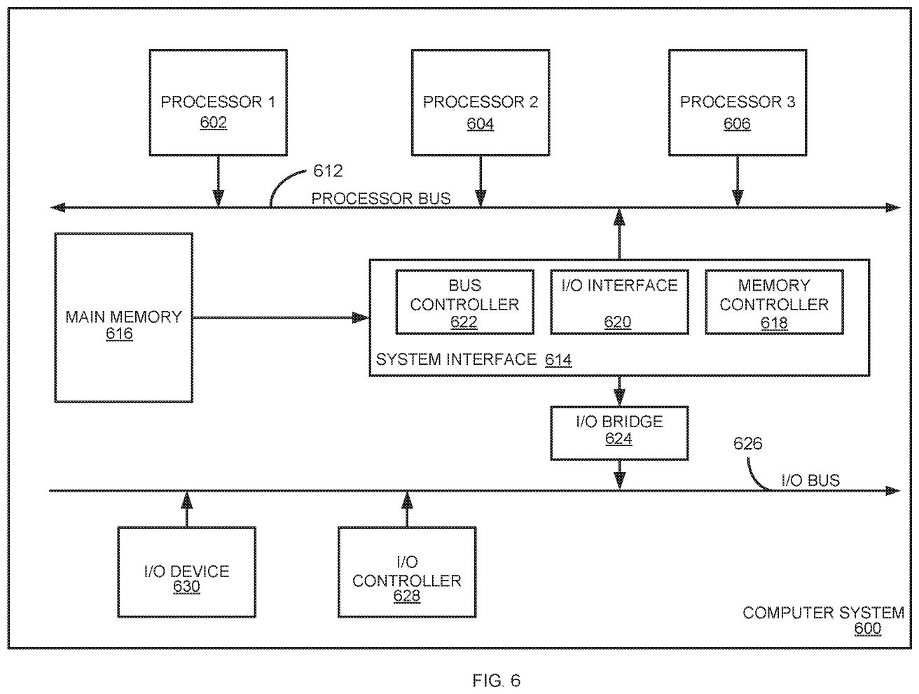

FIG. 6 is a block diagram illustrating an example of a computing device or computer system 600 which may be used in implementing the embodiments of the components of the network disclosed above. For example, the computing system 600 of FIG. 6 may be the provider edge device discussed above. The computer system (system) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 614 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 640, as illustrated.

I/O device 640 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium (e.g., floppy diskette or hard disk drive); optical storage medium (e.g., CD-ROM); magneto-optical storage medium; read only memory (ROM); random access memory (RAM); erasable programmable memory (e.g., EPROM and EEPROM); FLASH memory/FLASH drive; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A computer-implemented method for dispatching technicians, the method comprising:
receiving a request for scheduling a job, the request including location information;
accessing a list of service technicians and associated availability for each listed service technician, the list of service technicians comprising service technicians respectively associated with a skill set corresponding to the request;
generating a list of time windows to which the received request can be assigned, each time window associated with a respective service technician from the list of service technicians and associated with a prediction of generated revenue from the job, the prediction based on an identified time window, the respective technician, and the job; and
scheduling a selected service technician of the list of service technicians to undertake the job by associating the selected service technician with the identified time window and a type of service associated with the job.

2. The computer-implemented method of claim 1, wherein generating the list of time windows further comprises:
generating a bipartite graph comprising a first set of nodes associated with time windows associated with a particular technician of the list of service technicians, a second set of nodes associated unassigned jobs, and edges interlinking nodes of the first set of nodes and nodes of the second set of nodes, each edge associated with a cost value; and
solving the bipartite graph by iteratively removing edges until no two nodes are linked by more than one edge.

3. The computer-implemented method of claim 2, wherein the cost is a negative value based on a predicted value of work associated with a first respective node of the second set of nodes and a technician multiplier associated with a second respective node of the first set of nodes.

4. The computer-implemented method of claim 2, wherein solving the bipartite graph further comprises executing a maximum-flow-minimum-cost solver on the bipartite graph.

5. The computer-implemented method of claim 2, wherein iteratively removing edges from the bipartite graph further comprises performing simulated annealing over the bipartite graph.

6. The computer-implemented method of claim 1, performed on a scheduled basis at regular intervals.

7. The computer-implemented method of claim 1, further comprising sending an alert to a user device of the selected service technician, the alert identifying the identified time window, the job, and the job location information.

8. The computer-implemented method of claim 1, further comprising:
receiving information from a user device that identifies a time that the selected service technician arrived at a site that corresponds to the job location information;
receiving information from the user device that identifies a time that the selected service technician completed the job;
identifying a job duration by subtracting the job completion time from the job arrival time; and
updating the job information to include the job duration.

9. The computer-implemented method of claim 1, further comprising:
receiving information from a user device that identifies additional work that can be performed at a site that corresponds to the job location information; and
updating the job information to identify the additional work that can be performed at the job site.

10. The computer-implemented method of claim 9, further comprising sending an authorization to the user device indicating that the additional work can be performed by the selected service technician, wherein the additional work is performed based at least in part on the authorization.

11. The computer-implemented method of claim 9, further comprising:
accessing the list of service technicians and associated availability for each listed service technician, the list of service technicians comprising service technicians respectively associated with a skill set corresponding to the additional work;
identifying a second time window to which the received additional work can be assigned; and
scheduling the selected service technician or another service technician of the list of service technicians to undertake the additional work by associating the selected service technician or the another service technician with the time window and the additional work.

12. A non-transitory computer-readable storage medium having embodied thereon a program executable by a process for implementing a method for dispatching technicians, the method comprising:
receiving a request for scheduling a job, the request including location information;
accessing a list of service technicians and associated availability for each listed service technician, the list of service technicians comprising service technicians respectively associated with a skill set corresponding to the request;
generating a list of time windows to which the received request can be assigned, each time window associated with a respective service technician from the list of service technicians and associated with a prediction of generated revenue from the job, the prediction based on an identified time window, the respective technician, and the job; and
scheduling a selected service technician of the list of service technicians to undertake the job by associating the selected service technician with the identified time window and a type of service associated with the job.

13. The non-transitory computer-readable storage medium of claim 12, wherein generating the list of time windows further comprises:
generating a bipartite graph comprising a first set of nodes associated with time windows associated with a particular technician of the list of service technicians, a second set of nodes associated unassigned jobs, and edges interlinking nodes of the first set of nodes and nodes of the second set of nodes, each edge associated with a cost value; and
solving the bipartite graph by iteratively removing edges until no two nodes are linked by more than one edge.

14. The non-transitory computer-readable storage medium of claim 13, wherein the cost is a negative value based on a predicted value of work associated with a first respective node of the second set of nodes and a technician multiplier associated with a second respective node of the first set of nodes.

15. The non-transitory computer-readable storage medium of claim 13, wherein solving the bipartite graph further comprises executing a maximum-flow-minimum-cost solver on the bipartite graph.

16. The non-transitory computer-readable storage medium of claim 13, wherein iteratively removing edges from the bipartite graph further comprises performing simulated annealing over the bipartite graph.

17. The non-transitory computer-readable storage medium of claim 12, the program further executable to generate work schedules at regular time intervals.

18. The non-transitory computer-readable storage medium of claim 12, the program further executable to send an alert to a user device of the selected service technician, the alert identifying the time window, the job, and the job location information.

19. An apparatus for dispatching technicians, the apparatus comprising:
a memory; and
a processor that executes instructions out of the memory to:
receive a request for scheduling a job, the request including location information,
access a list of service technicians and associated availability for each listed service technician, the list of service technicians comprising service technicians respectively associated with a skill set corresponding to the request,
generate a list of time windows to which the received request can be assigned, each time window associated with a respective service technician from the list of service technicians and associated with a prediction of generated revenue from the job, the prediction based on an identified time window, the respective technician, and the job, and
schedule a selected service technician of the list of service technicians to undertake the job by associating the selected service technician with the identified time window and a type of service associated with the job.

20. The apparatus of claim 19, further comprising additional instructions executable by the processor for:
generating a bipartite graph comprising a first set of nodes associated with time windows associated with a particular technician of the list of service technicians, a second set of nodes associated unassigned jobs, and edges interlinking nodes of the first set of nodes and nodes of the second set of nodes, each edge associated with a cost value, and
solving the bipartite graph by iteratively removing edges until no two nodes are linked by more than one edge.
